(19) United States
(12) Patent Application Publication
(10) Pub. No.: US 2011/0255236 A1
(43) Pub. Date: Oct. 20, 2011

(54) DISK DRIVE ASSEMBLY

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/841,427

(22) Filed: Jul. 22, 2010

(30) Foreign Application Priority Data
Apr. 20, 2010 (CN) 201010151371.1

(51) Int. Cl. G06F 1/16

(52) U.S. Cl. 361/679.33

(57) ABSTRACT

A disk drive assembly includes a disk drive, a disk drive bracket, a fastener, and a securing element. The fastener is mounted on the disk drive and engaging the disk drive bracket to prevent the disk drive from moving along a first direction. The securing element includes a body, a resisting portion extending from the body, and a mounting portion extending from the body. A receiving space is defined between the body and the resisting portion. The disk drive is received in the receiving space. The securing element engages the disk drive bracket and receives the disk drive to prevent the disk drive from moving along a second direction.

### BACKGROUND

1. Technical Field

The present disclosure relates to disk drive assemblies.

2. Description of Related Art

A typical personal computer comprises disk drives such as a hard disk drive (HDD), a floppy disk drive, and a compact disc-read only memory (CD-ROM) drive. Conventionally, the disk drives are attached to a chassis of a computer enclosure using screws. A tool such as a screwdriver is required to fasten and unfasten the screws. The operations are laborious and time-consuming. Furthermore, a typical chassis of a computer enclosure for receiving disk drives takes a lot of physical space.

### BRIEF DESCRIPTION OF THE DRAWINGS

FIG. 1 is an exploded, schematic view of a disk drive assembly of an embodiment, the disk drive assembly including a disk drive bracket and a securing element.

FIG. 2 is an isometric view of the disk drive bracket of FIG. 1.

FIG. 3 is an isometric view of the securing element of FIG. 1.

FIG. 4 is an isometric view of a fastener of FIG. 1.

FIG. 5 is an assembled view of the disk drive assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

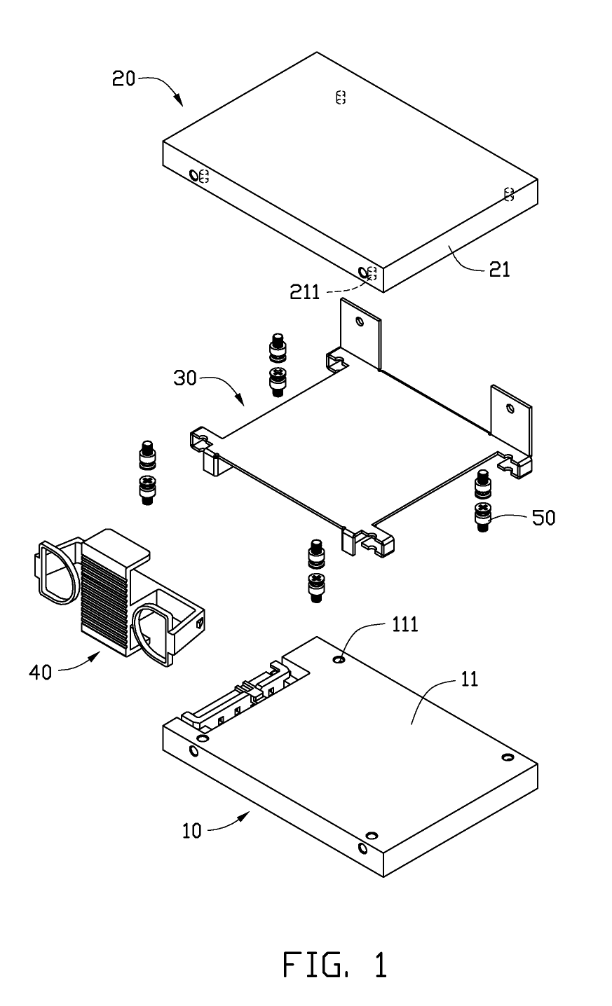

Referring to FIG. 1 a disk drive assembly includes a first disk drive 10, a second disk drive 20, a disk drive bracket 30, and a securing element 40.

The first disk drive 10 defines a first side surface 11. The first side 11 defines first mounting holes 111. The second disk drive 20 defines a second side surface 21. The second side surface 21 defines second mounting holes 211.

The disk drive bracket 30 includes a plane base 31, a first supporting portion 32, and a second supporting portion 33. The first supporting portion 32 and the second supporting portion 33 extend from opposite sides of a lower end of the base 31. U-shaped assembling portions 34 extend from the base 31. Each assembling portion 34 includes two assembling arms 341. Each assembling arm 341 defines an arc-shaped cutout 342. Two first securing portions 35 extend perpendicularly from the base 31. An engaging hole 352 is defined in each first securing portion 35. The two first securing portions 35 are parallel.

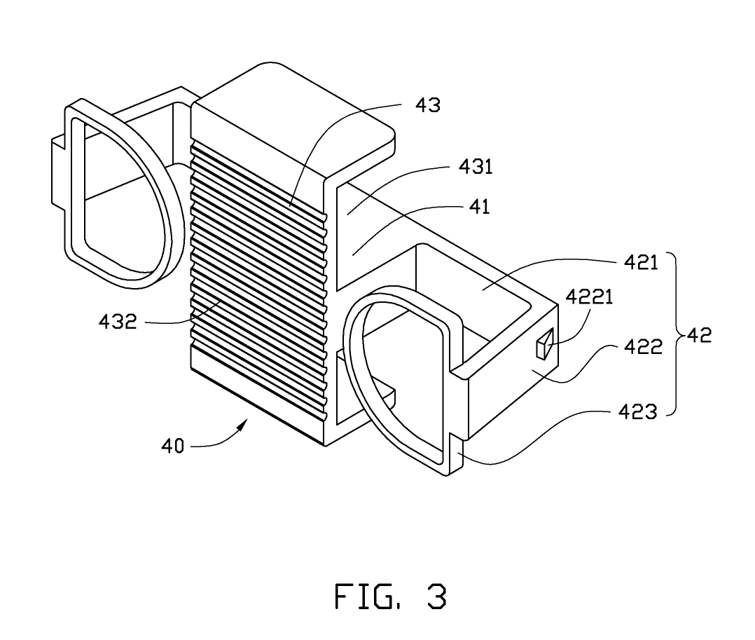

Referring to FIG. 3, the securing element 40 includes a body 41, a pair of mounting portions 42 extending from opposite sides of the body 41 in a first direction, and a pair of resisting portions 43 extending from opposite sides of the body 41 in a second direction perpendicular to the first direction. Each mounting portion 42 includes a resilient connecting portion 421 extending from the body 41, a second securing portion 422 extending perpendicularly from the connecting portion 421, and a handling portion 423 extending perpendicularly from the second securing portion 422. In one embodiment, the handling portion 423 is loop-shaped. Each second securing portion 422 includes an engaging portion 4221 corresponding to the engaging hole 352 of the disk drive bracket 30. Each resisting portion 43 is L-shaped. A receiving space 431 is commonly defined by each resisting portion 43 and the body 41. The resisting portion 43 includes a plurality of sequential grooves 432.

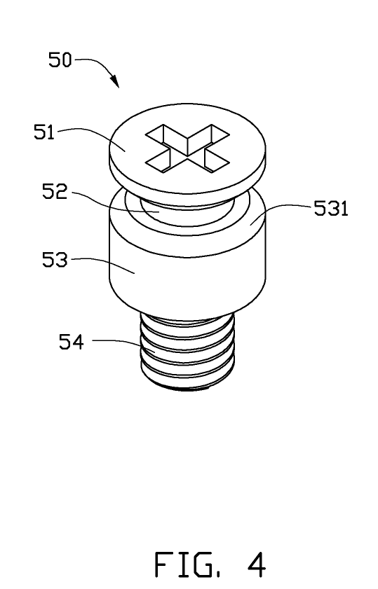

Referring to FIGS. 1 and 4, a plurality of fasteners 50 are configured to be respectively screwed into the first mounting holes 111 of the first disk drive 10 and the second mounting holes 211 of the second disk drive 20. Each fastener 50 includes a head portion 51, a neck portion 52 extending from the head portion 51, a body portion 53 extending from the neck portion 52, and a securing portion 54 extending from the body portion 53. The cross section of the neck portion 52 is less than that of the body portion and that of the head portion 51. The body portion 53 defines an inclining guiding surface 531 adjacent to the neck portion 52.

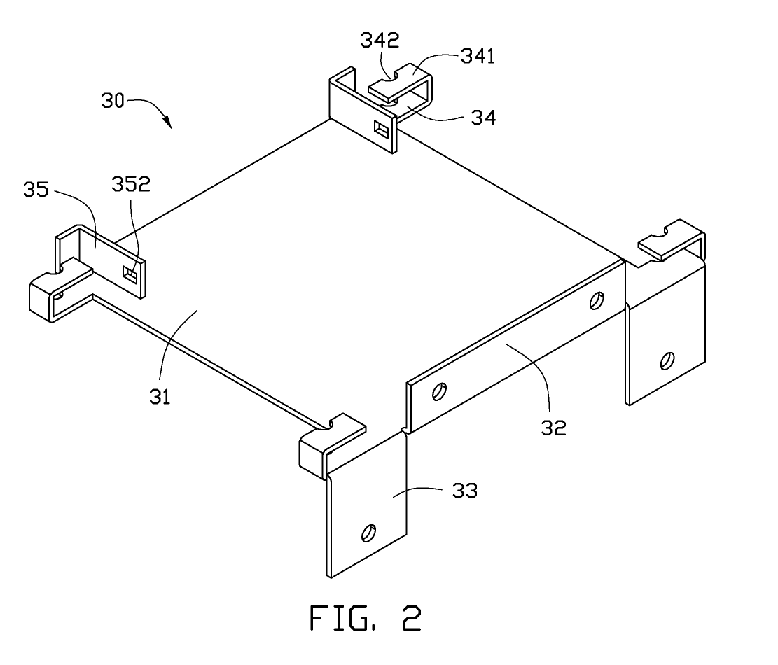

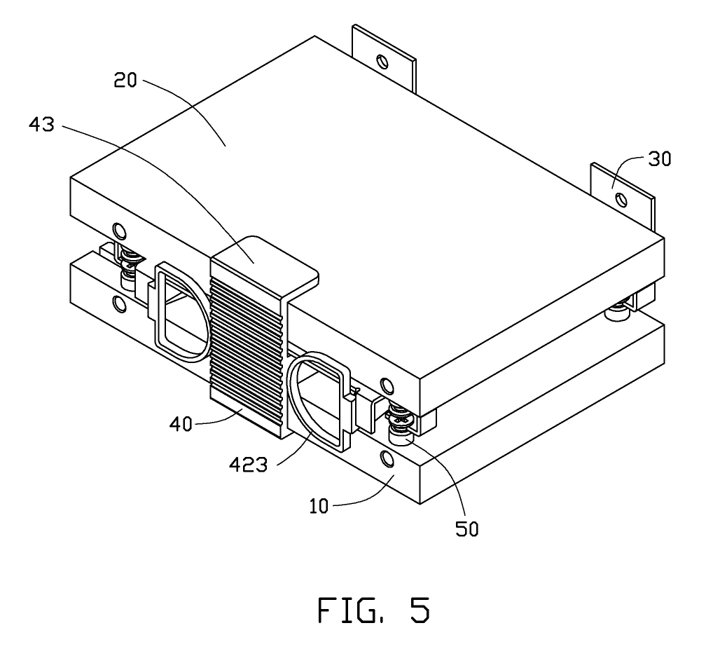

Referring to FIGS. 1 through 5, in assembly, a plurality of fasteners 50 are respectively screwed into the first mounting holes 111 of the first disk drive 10 and the second mounting holes 211 of the second disk drive 20. The plurality of fasteners 50 are then respectively placed in the cutouts 342 of the disk drive bracket 30. Each neck portion 52 is disposed in the cutout 342, and the head portion 51 and the body portion 53 from opposite sides of the corresponding cutout 342, thereby preventing the first disk drive 10 and the second disk drive 20 from moving along a first direction substantially perpendicular to the base 31. The body 41 of the securing element 40 is placed between the base 31 of the disk drive bracket 30 and the first disk drive 10. The two resisting portions 43 respectively correspond to the first disk drive 10 and the second disk drive 20. The second securing portion 422 of the securing element 40 corresponds to the first securing portion 35 of the disk drive bracket 30. The resisting portion 43 of the securing element 40 is moved to enable the engaging portion 4221 of the second securing portion 422 to engage the engaging hole 352 of the first securing portion 35. At this time, the first disk drive 10 and the second disk drive 20 are respectively received in the receiving spaces 431. The first disk drive 10 and the second disk drive 20 are parallel to the base 31 of the disk drive bracket 30. The two resisting portion 43 prevent the first disk drive 10 and the second disk drive 20 from moving along a second direction that is perpendicular to the first direction.

In disassembly, the two handling portions 423 are pulled close to the body 41 of the securing element 40, thereby driving the two engaging portion 4221 of the second securing portion 422 to disengage from the engaging hole 352 of the disk drive bracket 30. The securing element 40 is moved apart from the disk drive bracket 30. The first disk drive 10 and the second disk drive 20 are then moved apart from the disk drive bracket 30.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A disk drive assembly, comprising:
a disk drive;
a disk drive bracket;
a fastener mounted on the disk drive and engaging the disk drive bracket to prevent the disk drive from moving along a first direction; and
a securing element, the securing element comprising a body, a resisting portion extending from the body, and a mounting portion extending from the body; wherein a receiving space is defined between the body and the resisting portion, the disk drive received in the receiving space; the securing element engaging the disk drive bracket and receiving the disk drive to prevent the disk drive from moving along a second direction.

2. The disk drive assembly of claim 1, wherein the disk drive bracket comprises a first securing portion, and the mounting portion comprises a resilient connecting portion, extending from the body, and a second securing portion, extending from the resilient connecting portion; and the first securing portion engages the second securing portion.

3. The disk drive assembly of claim 2, wherein the mounting portion further comprises a handling portion extending from the second securing portion; and the first securing portion is capable of disengaging from the second securing portion by operating the handling portion.

4. The disk drive assembly of claim 3, wherein the handling portion is a loop-shaped.

5. The disk drive assembly of claim 2, wherein an engaging hole is defined in the first securing portion, and the second securing portion comprises an engaging portion that engages the engaging hole.

6. The disk drive assembly of claim 1, wherein the resisting portion is L-shaped.

7. The disk drive assembly of claim 1, wherein the disk drive bracket comprises a plane base and an assembling portion extending from the plane base; and the disk drive is parallel to the plane base, and the fastener engages the assembling portion.

8. The disk drive assembly of claim 7, wherein a cutout is defined in the assembling portion; the fastener comprises a head portion, a neck portion extending from the head portion, and a body portion extending from the neck portion; a cross section of the neck portion is less than that of the head portion and that of the body portion; and the neck portion is disposed in the cutout.

9. The disk drive assembly of claim 1, wherein the disk drive bracket comprises a supporting portion configured to support the disk drive.

10. A disk drive assembly, comprising:
a first disk drive;
a second disk drive;
a disk drive bracket, and the disk drive bracket comprises a plane base; the first disk drive and the second disk drive are located on opposite sides of the plane base; the disk drive bracket is configured to prevent the first disk drive and the second disk drive from moving along a first direction that is substantially perpendicular to the plane base; and
a securing element engaging the disk drive bracket and receiving the first disk drive and the second disk drive to prevent the first disk drive and the second disk drive from moving along a second direction that is substantially perpendicular to the first direction.

11. The disk drive assembly of claim 10, wherein two fasteners are respectively mounted on the first disk drive and the second disk drive; the two fasteners engage the disk drive bracket to prevent the first disk drive and the second disk drive from moving along the first direction.

12. The disk drive assembly of claim 11, wherein the disk drive bracket further comprises an assembling portion extending from the plane base; a cutout is defined in the assembling portion; each fastener comprises a head portion, a neck portion extends from the head portion, and a body portion extends from the neck portion; a cross section of the neck portion is less than that of the head portion and that of the body portion; and the neck portion is disposed in the cutout.

13. The disk drive assembly of claim 10, wherein the securing element comprises a body, two resisting portions extend from opposite sides of the body, and a first mounting portion extends from the body; two receiving spaces, wherein each receiving space is defined between the body and each resisting portion; the first mounting portion engages the disk drive bracket, and the first disk drive and the second disk drive are respectively received in the two receiving spaces.

14. The disk drive assembly of claim 13, wherein the resisting portion is L-shaped.

15. The disk drive assembly of claim 13, wherein the securing element further comprises a second mounting portion engaging the disk drive bracket; and the mounting portion and the second mounting portion are disposed from another opposite sides of the body.

16. The disk drive assembly of claim 10, wherein the disk drive bracket comprises a first securing portion, and the securing element comprises a resilient connecting portion and a second securing portion; and the first securing portion engages the second securing portion.

17. The disk drive assembly of claim 16, wherein an engaging hole is defined in the first securing portion, and the second securing portion comprises an engaging portion engaging the engaging hole.

18. The disk drive assembly of claim 10, wherein the first disk drive and the second disk drive are parallel to the plane base.

19. The disk drive assembly of claim 10, wherein the disk drive bracket comprises a supporting portion configured to support the first disk drive and the second disk drive.
